(19) United States
(12) Patent Application Publication
(10) Pub. No.: US 2015/0039439 A1
(43) Pub. Date: Feb. 5, 2015

(54) Retailer-Controlled Showrooming

(71) Applicant: UniteU Technologies, Inc., Pittsford, NY (US)

(72) Inventors: Soumen Das, Pittsford, NY (US); Lou Leone, Rochester, NY (US)

(73) Assignee: UniteU Technologies, Inc., Pittsford, NY (US)

(21) Appl. No.: 13/958,958

(22) Filed: Aug. 5, 2013

(51) Int. Cl. G06Q 30/02

(52) U.S. Cl. CPC G06Q 30/0267
USPC 705/14.64

(57) ABSTRACT

A method for offering a purchase incentive from a retail merchandiser to a retail customer through a handheld customer communications device is executed at least in part by a computer system and includes receiving, at a first processor having a network address, data from an encoding that is scanned and wirelessly transmitted from the handheld customer communications device. A product that is associated with the encoding data is identified and a wireless address that is associated with the handheld customer communications device is recorded. The method further includes transmitting, from the first processor, pricing information for the identified product for display on the handheld customer communications device at the recorded wireless address and responding to a customer selection from the transmitted pricing information by transmitting an incentive message for display on the handheld customer communications device at the recorded wireless address.

### FIELD OF THE INVENTION

The present application relates generally to systems and methods for pricing negotiation and communication between customers and retailers of products and more particularly to a system for providing in-store pricing comparison with on-line retailers and purchase incentives based on the comparison.

### BACKGROUND OF THE INVENTION

The rapid acceptance and adaptation of smartphones and other wireless personal communications devices challenges a number of conventional models for the relationship between retailers of products and their customers. Customers who are equipped with smartphones, for example, can readily obtain information about product specifications, performance, and pricing for an item within the store without interacting with the sales staff. The customer can quickly learn about the product, read reviews that mention pros and cons and compare one product with similar offerings, and check prices set by other retail and online competitors.

This capability can present a particular difficulty to the conventional retailer who deals with customers in person at a retail location that is leased or owned by the retailer or retail chain. The conventional “brick and mortar” retailer incurs the cost of building ownership or leasing, sales staff training and monitoring, maintaining the safety and comfort of customers and employees, merchandise display, theft prevention, and other expenses related to maintaining one or more retail sites. Many of these costs are not shared by competitors who sell products online and who may not have retail sites. Thus, online competitors can often provide better pricing than is available from retail stores, even when shipping costs are included in the total.

One problem that has been particularly noted by retail merchants relates to a familiar customer practice termed “showrooming”. During a store visit, a customer may inquire about a product, consult with sales staff, participate in or watch a demonstration of product use, and obtain pricing information, all as part of the pre-sales service the retailer normally provides. Then, the customer may subsequently check pricing online at any of a number of other competitors' retail sites and order the same product from an alternate source for shipment and delivery. This can be particularly painful for the retailer when the customer has a smartphone or similar device. Simply scanning the bar code or taking an image of the product can allow access to web pages with considerable information from competitors, both retail and online. In some cases, the customer can even order the product from a retail competitor, such as an online retailer, and complete the transaction while still in the store operated by a first retailer.

Retail merchandisers who are sensitive to this problem are understandably cautious about how to solve it. Only a certain amount of cost cutting is desirable or possible. Other solutions, such as initiatives that block access to information or make it more difficult to obtain pricing information online, for example, appear to be short-sighted and are likely to backfire. An approach that can keep the customer working with the retailer at the retail site to obtain the best price, including the capability to allow for some amount of consumer incentive, negotiation, and adjustment, can have advantages for both the customer and the retailer and can help the retailer to maintain customer loyalty where pricing differences might otherwise cause loss of business.

### SUMMARY OF THE INVENTION

Embodiments of the present invention address the need for providing and responding to competitive pricing information for in-store retailers. Advantageously, the method of the present invention allows the retailer to incent the customer to purchase from the retail store, even where the stated price for another store or online source is lower. This gives the in-store retailer a number of options for increased sales and improving relationships with customers.

According to an embodiment of the present invention, there is provided a method for offering a purchase incentive from a retail merchandiser to a retail customer through a handheld customer communications device, the method executed at least in part by a computer system and comprising:
a) receiving, at a first processor having a network address, data from an encoding that is scanned and wirelessly transmitted from the handheld customer communications device;
b) identifying a product that is associated with the encoding data;
c) recording a wireless address that is associated with the handheld customer communications device;
d) transmitting, from the first processor, pricing information for the identified product for display on the handheld customer communications device at the recorded wireless address;
and
e) responding to a customer selection from the transmitted pricing information by transmitting an incentive message for display on the handheld customer communications device at the recorded wireless address.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a schematic diagram showing portions of the processing hardware that are used according to an embodiment of the present invention.

FIG. 2 is a logic flow diagram that shows a sequence for customer interaction with the price comparison application according to an embodiment of the present invention.

FIG. 3 shows scanning of a QR code.

FIG. 4A shows a price comparison display.

FIG. 4B shows a price comparison display with a price match instruction.

FIG. 5 shows a prompt for customer contact information.

FIG. 6 shows a logic flow diagram for a sequence that generates and transmits an incentive message to the customer.

FIG. 7 shows an example of an incentive message that displays on a customer communications device.

### DETAILED DESCRIPTION OF THE INVENTION

The following is a detailed description of the preferred embodiments of the invention, reference being made to the drawings in which the same reference numerals identify the same elements of structure in each of the several figures. For clarity of description, a number of supporting components that would be used in a system that uses methods of the present invention are not shown in the accompanying figures, such as power supplies, antennae, and other types of standard components used for computing and communication between different systems. Those skilled in the networking and wireless communications arts can readily recognize that there are a number of alternative systems and solutions available for providing the communication of data and execution of programmed instructions described herein.

Where they are used, the terms “first”, “second”, and so on, do not necessarily denote any ordinal, sequential, or priority relation, but are simply used to more clearly distinguish one element or step, or set of elements or steps from another, unless specified otherwise.

In the context of the present disclosure, the term “in-store retailer” relates to the retail staff for a store that has a particular geographical location, wherein the store provides retail sales to customers who enter the store building. The term “retail merchandiser” relates to an entity that manages one or more retail stores. For a retail chain, for example, the retail merchandiser can be a centralized regional or headquarters managerial authority that is authorized to negotiate pricing and to define purchase incentives. The in-store retailer deals with the customer in person, as opposed to other product sources, such as online product merchandisers who sell to customers over a networked data connection.

In the context of the present disclosure, the general term “customer communications device” is broadly used to encompass any of a number of types of handheld wireless portable personal communications devices that are carried by a customer, including cellular phones, so-called “smartphones” that provide some type of mobile operating system, feature phones having at least some measure of computing capability, and various types of wireless, networked electronic pads, tablets, and similar devices that may or may not include a phone and that include at least a display area capable of displaying text and graphic content, a scanner, and a mechanism for entering data, such as phone numbers, message text, and prompt responses, for example. The mechanism for data entry typically includes a touch screen and may also include a keypad. Examples of handheld customer communications devices that can be particularly useful for embodiments of the present invention include commercially available smartphones such as the Android™ smartphone platform (Android is a trademark of Google, Inc.), the iPhone (from Apple Inc.), and devices with similar capability for downloading and executing one or more sets of programmed instructions, such as software applications that are widely referred to as “apps” that display on the device. In the context of the present invention, the term “app” is considered to be synonymous with the phrase “software application” or “software application program” and relates to a set of programmed instructions that execute on a computer or other logic processor, such as the logic processor that controls operation of a smartphone or other handheld customer communications device.

The customer communications device has at least one wireless address and may have multiple addresses that allow wireless communication in different modes or from different sources. In the context of the present disclosure, the term “wireless address” refers to an identifying electronic address that is used for wireless signal communication to the customer communications device. For a smartphone, for example, the wireless address that is associated with the device can be a phone number, but optionally can be some other type of wireless address, such as an IP address or address of a network interface card or other device that supports wireless communication to and from the customer communications device. Association of the device to a particular wireless address may also be through a user account that is accessible when using the customer communications device.

In the context of the present disclosure, the term “user-actuable link” refers to an icon or other graphic element that is graphically represented on a display screen of a communications device and that, when selected by a user, such as using a touch screen contact or other pointing mechanism, initiates execution of one or more stored programmed instructions that are intended to be used one or more times following initial installation of corresponding software. With respect to the software interaction described herein, the terms “customer”, “purchaser”, and “user” are considered to be synonymous. With respect to the retail environment, the terms “products” and “items” are used synonymously to indicate goods or services that are for sale.

In the context of the present disclosure, the term “host application” relates to a software program that executes on a processor of some type, such as a computer or other logic processor, including one or more networked computer or computers or processors.

In the context of the present disclosure, the term “purchase incentive” or “incentive message” that provides a purchase incentive, relates to an offer from the retail seller that can be redeemed by the potential purchaser. According to embodiments of the present invention, an incentive is provided in the form of a message that is generated and wirelessly transmitted to the customer communications device of the potential purchaser for display and use. The incentive message may list a price for an item that is available to the purchaser following interaction with the application, which may be the price of a scanned item that is on display at the retail store, of an alternate item that may be available but may or may not be on display, or of a collection of items, such as a “bundled” equipment or product offering, that include the scanned item or its equivalent. Alternately, the incentive message may be an electronically presented coupon that is negotiable for the purchaser and that can be used toward purchase of the product that corresponds to the scanned label or purchase of one or more items or related services, such as for service plans or for other items related to the item scanned by the customer in the store, for example. A purchase incentive for a desktop printer may be a coupon offering a sizable discount on a compatible ink cartridge, for example. Thus, the purchase incentive need not be limited to an incentive that directly offers credit toward the purchase price of an item offered by the retail merchandiser. Moreover, the purchase incentive need not necessarily be directly related to a particular product, but may more broadly include promotions, coupons or tickets for reduced price use of facilities or events, such as tickets to a game, a golf course or driving range, a show or performance, or tickets to a different venue, such as for a restaurant discount, for example. According to an embodiment of the present invention, the purchase incentive that is provided electronically to the customer displays on the handheld customer communications device and may have a stated time limit, such as 2 hours, 24 hours, or one week, for example. The retailer can include various terms and requirements for redeeming the coupon or other purchase incentive.

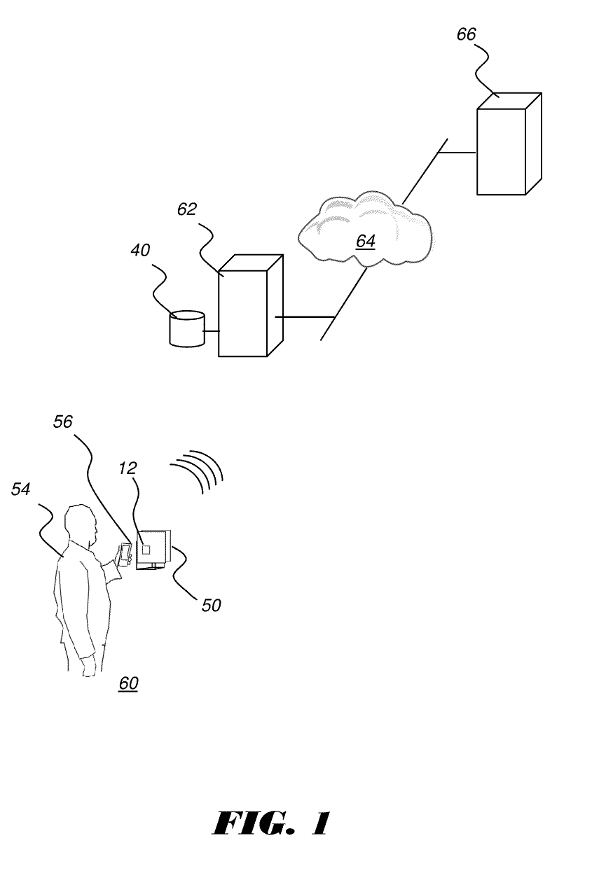

FIG. 1 shows, in schematic form, the overall relation between systems and apparatus that allow interaction between the purchaser and the retail merchandiser, consistent with an embodiment of the present invention. A product 50 on display at a retail store 60 has an associated label 12. A customer 54 uses a smartphone or similar handheld customer communications device 56 to scan label 12 and initiate wireless communication with a networked processor 62 that may be on-site or in a different location. Networked processor 62 is in signal communication with a memory 40, which may be internal or external to the processor 62 hardware chassis. Memory 40 is used to record or to store data related to customer interaction, as described in more detail subsequently. Networked processor 62, at a first network address, communicates wirelessly with customer communications device 56 and, additionally, can communicate with one or more other processors 66 at other network addresses over a network 64, represented as a cloud in FIG. 1. Communication between two or more networked processors 62 and 66 at different network addresses may use wired connections or may be wireless, or may use some combination of wired and wireless communication. Embodiments of the present invention are directed to encouraging customer 54 to purchase an item within the store 60, even if the customer can determine that a lower price is available for the item at some other retail location or through some alternate on-line vendor. Processor 62 is in signal communication with one or more internal or external wireless transceivers (not shown) for wireless communication with one or more customer communications devices 56. Connection with transceiver apparatus may be through network 64, such as through a commercial wireless communications provider; alternately, this transceiver connection may be internal to, or local to, processor 62.

Those skilled in the wireless communication arts and in the art of creating applications or “apps” for smartphone and other handheld customer communications devices can readily appreciate that the embodiment shown in FIG. 1 is exemplary only and that any of a number of variable hardware arrangements for wireless communication to customer communications devices 56 for exchanging pricing information, receiving customer instructions, and sending purchase incentives electronically to the customer are possible. Embodiments of the present invention are not restricted to any particular configuration, but can be used with any arrangement that provides communication, processing, and operator interaction that implement the steps and processes of the invention as claimed.

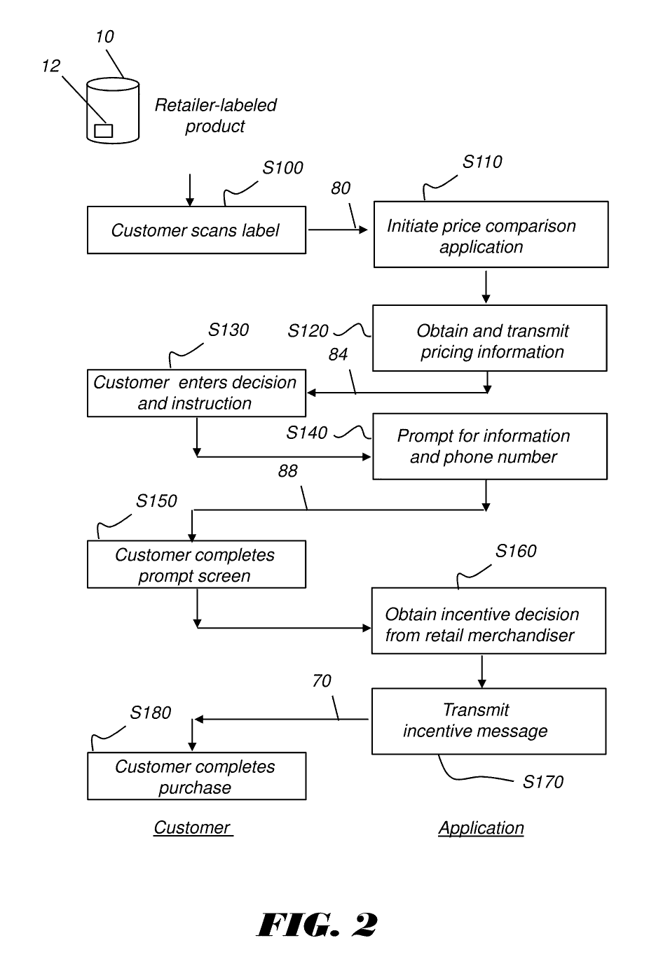

The logic flow diagram of FIG. 2 shows a sequence of steps for retailer-controlled showrooming according to an illustrative embodiment of the present invention. Application steps appear in the column of steps toward the right in FIG. 2; customer steps appear to the left. The price comparison application that executes allows the in-store retailer to interact with a customer for price comparison and to incent the customer to purchase a product 10 while at the retail site. In preparation for this sequence, the retailer applies label 12 to product 10. Label 12 has an encoding that is scannable using a smartphone or other type of handheld customer communications device. Label 12 is scanned in a scan step S100. The scanned encoding provides address information that can be used by a software application installed on the handheld customer communications device having a wireless address to transmit a message to a host application running on a logic processor that has a first network address, shown as processor 62 in FIG. 1. The scan can be performed by the customer or by the retail staff assisting the customer, using the customer communications device. Information provided in this initial wireless transmission 80 can include various useful information that is encoded on scanned label 12, or is readily identifiable using the encoding from the scanned label 12, such as product type and model number, store location, pricing, and other product-related information. For product identification, product information can be directly encoded on label 12 or may be accessed from a database or look-up table (LUT) that is accessible to processor 62, based on information obtained from the label 12 encoding, for example. In addition, the wireless transmission also provides the phone number or other wireless address of the smartphone or other customer communications device 56 that was used to scan label 12.

Advantageously, embodiments of the present invention can record and use the encoded information from the initial wireless transmission 80 obtained from scan step S100 to establish ongoing wireless communication and help to improve interactivity between the retailer and the customer. The message transmission that results from scan step S100 has a number of useful aspects; use of the information obtained provides new ways to foster and nurture the retailer-customer relationship. As one benefit for enhanced interaction, the initial message provides information that allows quick response from the in-store retailer. Because the system represented by processor 62 in FIG. 1 can be controlled by the retailer or can be accessible to the retailer, local store management can be alerted as soon as any customer in their store scans a product 10. For quick response, store clerks or other personnel can be routed to the appropriate location in order to address any customer questions about the scanned product. The sales staff can even be provided with the customer name, obtained from a directory using the phone number or other wireless address. When the customer phone number is provided as part of the scan step S100 data, store management can respond directly by dialing the phone number and calling the customer on the same smartphone or other device immediately following the scan.

Improved interactivity with the customer can also be provided for future customer contact. For longer term response, data including customer phone number and product(s) scanned are recorded and can be used to track customer interests and appeal to customer interests and preferences at a later date. For example, the retail merchandiser can check back a few days later with a customer who scanned a particular type of product in order to learn whether or not the customer has found a suitable product of that type for purchase. The “browsing” or non-committing consumer can thus be identified, allowing the retailer to approach this customer in the future as a prospective buyer who has evidenced at least some interest in the product(s) browsed.

For retail management, the transmission that results from scan step S100 provides statistical data that relates to relative interest in a particular retail product 10 and, over time, can help to gather market research data on interest in particular products at specific retail sites. The information obtained can also be used to help measure customer buying patterns and similar data.

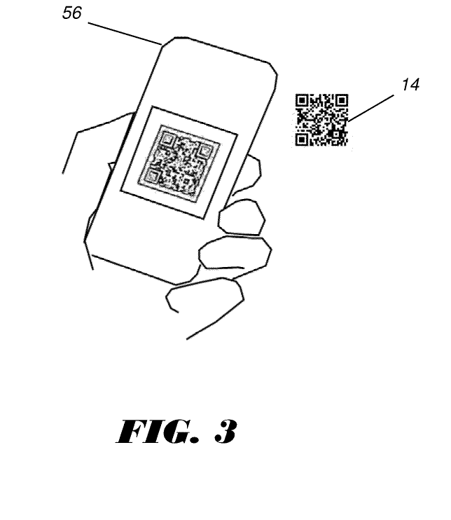

According to an embodiment of the present invention, label 12 provides a QR (Quick Response) code or other encoding that is customized for the retail merchandiser and for the product. Label 12 is associated with the retail product 50, such as by being affixed or attached to product 50 or its packaging or by being displayed where product 50 is shown or stocked. Label 12 can also be provided on a hand-out sheet that is available to the customer. FIG. 3 shows scanning of a QR code 14.

As shown in FIG. 2, scanning the label 12 encoding with a smartphone as handheld customer communications device 56 transmits the initial wireless transmission 80 that also initiates execution of a price comparison application in an initiation step S110. Relative to the generalized system shown in FIG. 1, initiation step S110 is managed from the host application on host processor 62 at the first network address. An obtain and transmit pricing step S120 acquires pricing information for the product. Pricing and other information is obtained from the retail merchandiser, which typically includes the in-store price, along with any timely sales offer information. Step S120 also acquires pricing from one or more alternate, competitive sellers, including online product merchandisers, for example. Step S120 typically obtains data from a site that publishes competitor prices for the same or similar products, enabling quick comparison of prices from multiple online and brick-and-mortar retail outlets. Alternately, step S120 can obtain data directly from one or more competitor sites, such as for retail stores within a given distance of the retail site where the product is scanned.

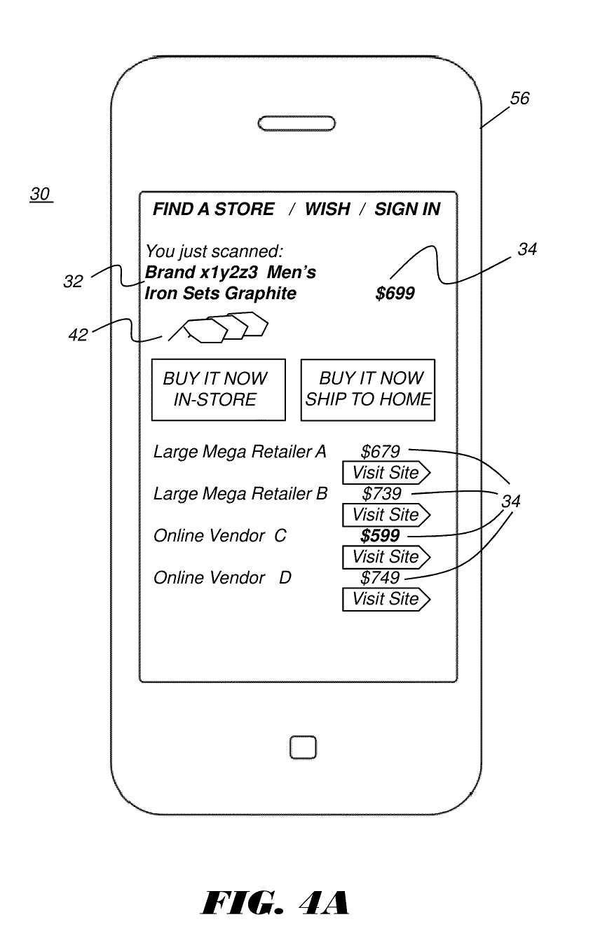

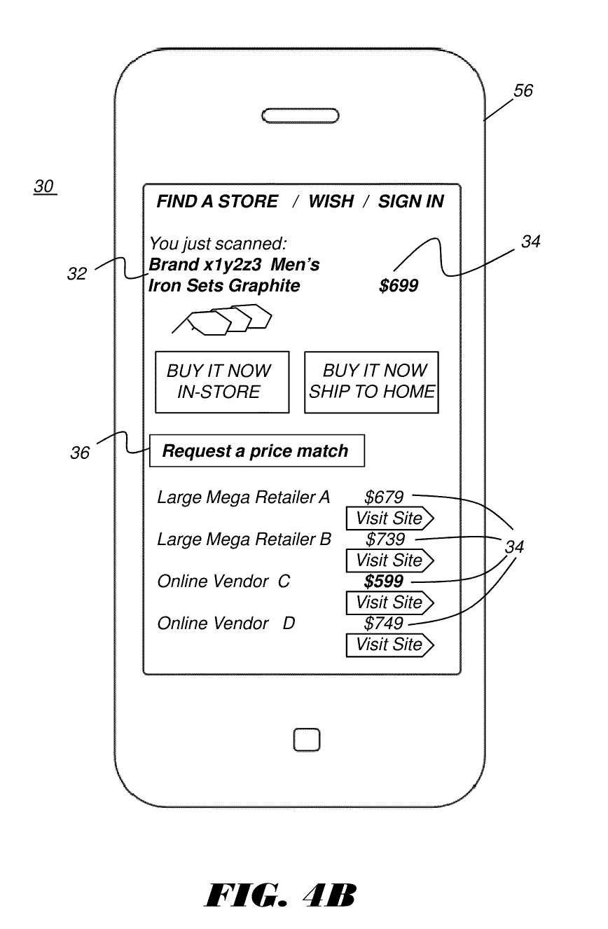

Continuing with the sequence of FIG. 2, step S120 then transmits this information as a pricing message 84 from the network address to the handheld customer communications device that is at the wireless address. A decision entry step S130 then executes, in which the customer is presented with a display that shows the retail merchandiser's price and lists alternate prices from one or more competitive sellers. By way of example only, and not by way of limitation, FIGS. 4A and 4B show a basic layout for a price comparison display 30 that appears on the handheld customer communications device. A product identifier 32 shows the product, with model number and other useful descriptive data and may also, or alternately, show an image 42 of the product, such as a thumbnail image at reduced scale. A listing 34 provides information on product pricing from the retail merchandiser and from one or more alternate sources. To continue with the pricing application, the customer selects from this listing or specifies a price match instruction 36. The customer selection is then transmitted back to the host application as an instruction. The customer may also select other options from price comparison display 30, such as for product information, description and reviews, and product demos and videos, for example.

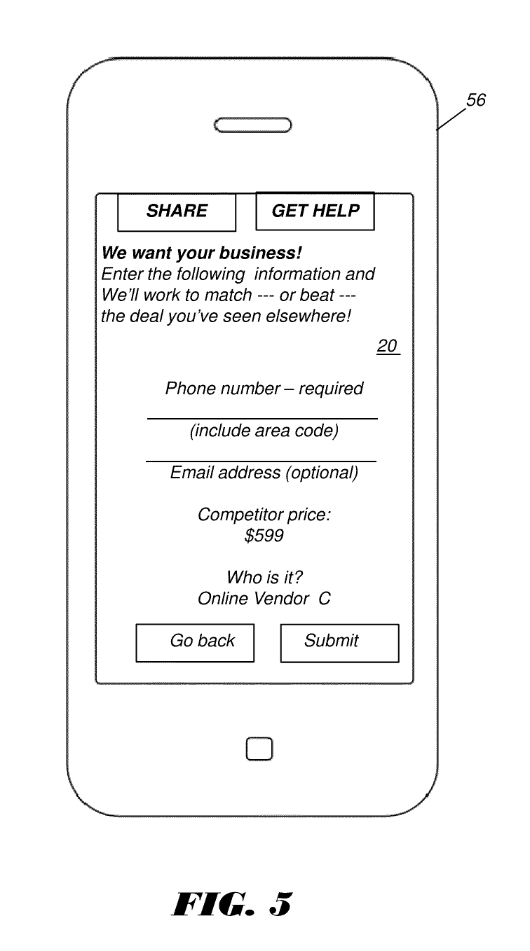

Still continuing with the FIG. 2 sequence, a prompt step S140 from the host application processor then transmits a prompt message 88 that instructs customer communications device 56 to provide a display that prompts the user for entry of identifying information, including phone number and, optionally, other useful details including alternate contact information, such as email address. The phone number can be automatically obtained and recorded from the scanning customer communications device 56, for example, and displayed by default, allowing the customer to enter alternate contact information. FIG. 5 shows an example of a prompt 20 transmitted from the host application and displayed on the handheld customer communications device for completion by the customer. In a prompt completion step S150 (FIG. 2), the customer enters the needed contact information in the prompt 20 screen. This is transmitted back to the host application. In an obtain merchandiser decision step S160, the host application directs the pricing decision information to the retail merchandiser, or to logic instructions that are associated with the retail merchandiser, in order to determine how to respond with a purchase incentive for the customer. An incentive transmission step S170 transmits the incentive back to the handheld customer communications device as an incentive message 70. The customer completes a purchase in a completion step S180.

Obtain merchandiser decision step S160 can be executed in any number of ways, depending on how the retail merchandizing management decides to handle customer incentives, pricing negotiation, and adjustments. According to an embodiment of the present invention, a customer sales representative actively monitors the price comparison application for the appropriate retail merchandiser and responds with an incentive that is appropriate to each case. This allows special treatment for repeat customers, for example, or for particular store locations where the retail merchandiser is motivated to interest and attract new customers. This can also allow the retailer to adjust incentives for changing local or regional market conditions or to attempt to reduce inventory, such as during slow sales periods. According to an alternate embodiment of the present invention, a computer program processes the pricing decision, applying rules for incentive amounts and types determined beforehand by the retail merchandiser.

Depending on factors such as the complexity of pricing policies, there can be some brief delay before step S170 executes. A message indicating this can be sent to the customer. For later transmission of incentive message 70, the phone number or email address of the handheld customer communications device 56 may be used to re-establish contact with the customer following delay.

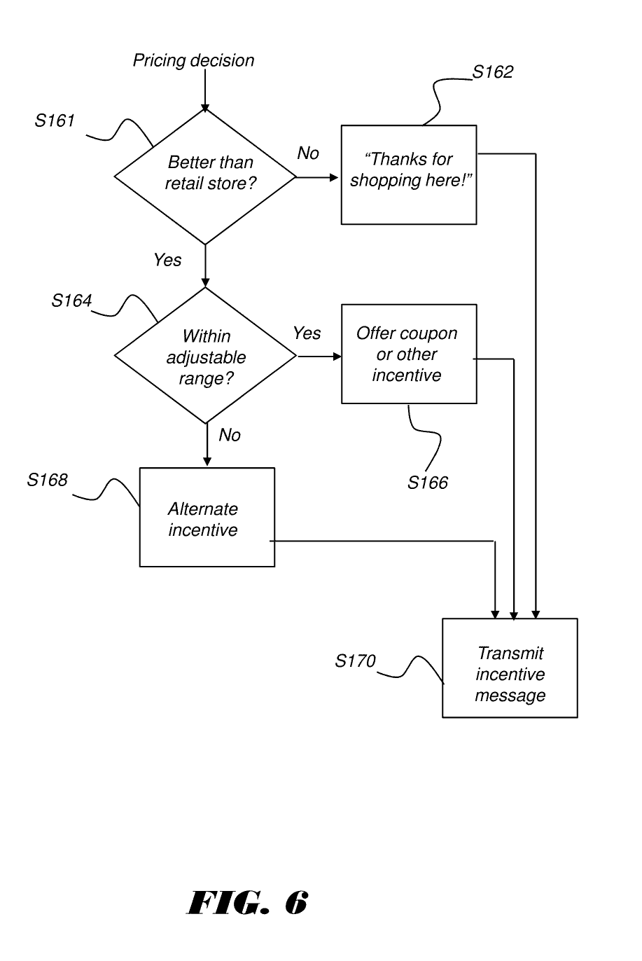

Consistent with an embodiment of the present invention, the logic flow diagram of FIG. 6 shows how incentive message 70 is generated. Where the competitor price is the same or higher, a decision step S161 initiates a message generation step S162 that generates a message thanking the customer for shopping at the retail store. An incentive message 70 may still be generated in this case, thanking the customer for working with the retailer to purchase an item. Where the competitor price is less, a decision step S164 determines whether or not the price discrepancy is within a range acceptable for adjustment by the retail merchandiser. If the price discrepancy is within a threshold range, such as 10% or less, this sequence directs the response to an adjustment step S166 that offers a coupon or other incentive that can motivate the customer to purchase the item from the retailer.

It should be noted that the incentive coupon or other device used as incentive message 78 may not, in practice, need to bring the final price to a value below that of the lowest competitor. Instead, the incentive message contents can effectively lower the price to within a range that is closer to a competitor's price, but where the total price that would be paid, when subtracting the coupon value, is still above the price charged by the competitor. Thus, for example, a customer may consider the convenience of immediate purchase, at a slightly higher price at the retail location, rather than purchasing online or at another retailer, due to considerations of “hidden” costs such as time spent, convenience, travel, shipping delay, or actual costs required to obtain a product, such as shipping, insurance, and other expense.

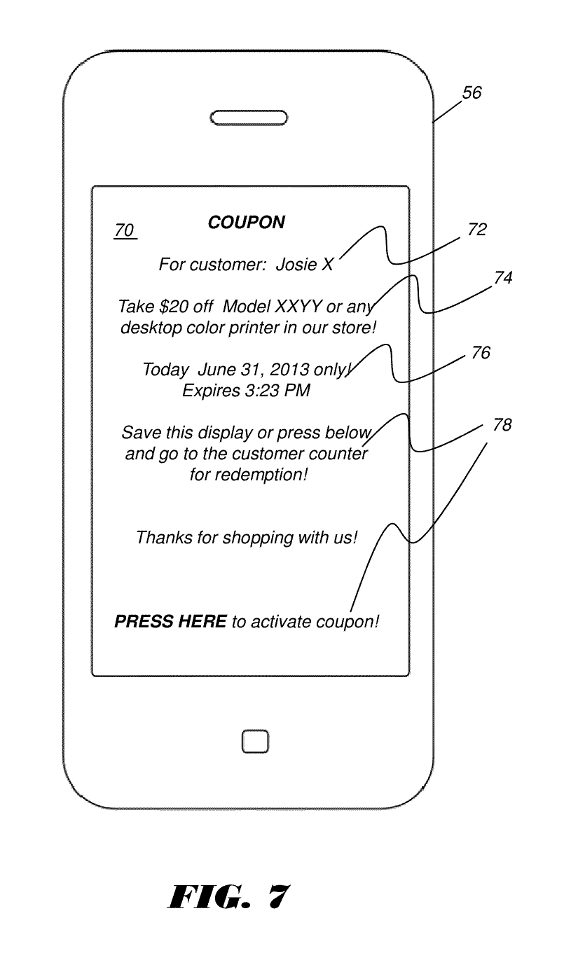

It should also be noted that the type of incentive may be a coupon, certificate, or other device that applies toward the purchase price. The coupon that is provided can be unique in each case, even where the same customer selection is made for a product. The incentive may be in the form of a coupon that is redeemable against the purchase price, such as a coupon for a percentage discount or for an exact discount value. However, as noted earlier, the incentive can also include promotions, such as reduced pricing coupons for groups of items bought at the same time, coupons with reduced prices or reduced-percentage pricing based on purchases above a certain cost or for purchase of multiple items in a single “bundled” package, coupons for reduced price service contracts or warranty extensions, gift certificates, reduced price admission tickets, coupons for other types of businesses, or coupons or certificates redeemable for give-a-ways in the store or elsewhere, for example. The electronic coupon can also be for an alternate product from another manufacturer (such as a desktop printer from a different manufacturer or of a different model type) or may apply for all products of the same type that are available from the retailer (such as for all desktop printers in the store). This capability gives the retail merchandiser considerable leeway for boosting sales volume or clearing the shelves of discontinued items without requiring “published” pricing reductions. Coupon or certificate expiration dates can also be set to allow the retailer to motivate the customer to make a quick decision. FIG. 7 shows one example of a typical incentive message 70 generated and displayed on customer communications device 56 as a result of step S170 in FIG. 2. In this example, incentive message 70 has an optional customer identifier 72, an incentive offer 74, an optional expiration date and time 76 and optional instructional content 78 for obtaining the purchasing incentive. It can be appreciated that any of a number of alternative arrangements is possible for incentive message 70, including an arrangement that offers the customer two or more alternative purchase incentives.

Methods of encoding data, such as the data that forms a QR code encoding, are well known to those skilled in the image encoding arts. As noted earlier, the encoding in label 12 (FIG. 2) can include product and store data or may include a pointer to data, such as to data that is stored in a look-up table (LUT) on another processor, for example.

According to an alternate embodiment of the present invention, the QR encoding shown in FIG. 3 is not needed to initiate the message sequence shown in FIG. 2. Instead, the customer captures an image of the product and this image is uploaded by the customer communications device, along with information that identifies the retail store. Image recognition software, familiar to those skilled in the image processing arts, can then determine the product or product type and respond accordingly.

There are also additional options that relate to the products that are offered and displayed. According to an alternate embodiment of the present invention, price comparison display 30 is populated with products that are similar, but may not be identical in model number or manufacturer. This gives the customer the opportunity to view products that are competitive but not exactly the same, as well as the opportunity to view accessories and related products that might be available at the retail site.

Some portions of the detailed description provided herein are presented in terms of algorithms and symbolic representations of operations on data bits within a computer memory, whether on a processor, customer communications device, or other computer or processor type. As is well known, algorithmic descriptions and representations are routinely used by those skilled in the data processing arts to most effectively convey the substance of their work to others skilled in the art. An algorithm is here, and generally, conceived to be a self-consistent sequence of steps (instructions) leading to a desired result. The algorithms of the present invention are stored in one or more sets of programmed instructions. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

It should be noted that the process steps and set of programmed instructions of the present invention could be embodied in software, firmware or hardware, and when embodied in software, could be downloaded to reside on and be operated from different platforms used by a variety of operating systems. Processing and storage can be performed at a local processor, such as a processor at the vendor site or at a remote networked processor, or at some combination of local and remote processors.

The present invention also relates to an apparatus for performing the operations herein. This apparatus may be specially constructed for the required purposes, or it may comprise one or more general-purpose computers selectively activated or reconfigured by computer programs stored in the computer. Such a computer program may be stored in a computer readable storage medium, such as, but is not limited to, any type of disk including magnetic disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

It should be noted that the term “memory”, in the context of the present disclosure, can refer to any type of temporary or more enduring data storage workspace used for recording or storing and operating upon data in a computer system and in signal communication with networked processor 62. The memory could be, for example, a long-term storage medium such as magnetic or optical storage internal or external to processor 62. Alternately, the memory could be an electronic circuit, such as random-access memory (RAM) that is used as a temporary buffer or workspace by a microprocessor or other control logic processor device, such as to record a phone number or other wireless address. Display data, for example, is typically stored in a temporary buffer and refreshed as needed in order to provide displayed data. This temporary storage buffer can also be considered to be a memory. Memory can be volatile, non-volatile, or a hybrid combination of volatile and non-volatile types. Memory can be stored at the retail site; however, a remote computer or other networked server could alternately store customer data and allow access to this data from the retail site.

The algorithms and displays presented herein are not inherently related to any particular computer, processor, communications device, or other apparatus. With reference to the sequence shown in FIG. 2, for example, some part of the sequence may execute on customer communications device 56 or on some other processor, such as a networked processor. Various general-purpose systems may also be used with programs in accordance with the teachings herein, or it may prove convenient to construct more specialized apparatus to perform the required method steps. The required structure for a variety of these systems will appear from the description given earlier. In addition, the present invention is not described with reference to any particular programming language. It will be appreciated that a variety of programming languages may be used to implement the teachings of the present invention as described herein, and any references to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. The invention is defined by the claims.

1. A method for offering a purchase incentive from a retail merchandiser to a retail customer through a handheld customer communications device, the method executed at least in part by a computer system and comprising:
a) receiving, at a first processor having a network address, data from an encoding that is scanned and wirelessly transmitted from the handheld customer communications device;
b) identifying a product that is associated with the encoding data;
c) recording a wireless address that is associated with the handheld customer communications device;
d) transmitting, from the first processor, pricing information for the identified product for display on the handheld customer communications device at the recorded wireless address;
and
e) responding to a customer selection from the transmitted pricing information by transmitting an incentive message for display on the handheld customer communications device at the recorded wireless address.

2. The method of claim 1 wherein transmitting the incentive message comprises transmitting a coupon for display on the handheld customer communications device.

3. The method of claim 2 wherein the coupon includes the name of a customer, wherein the name is associated with the wireless address that is associated with the handheld customer communications device.

4. The method of claim 2 wherein the coupon is redeemable for purchase of a second product that is an alternative to the identified product.

5. The method of claim 1 wherein responding to the customer selection further comprises interacting with the retail merchandiser to determine the incentive.

6. The method of claim 1 wherein transmitting the pricing information comprises transmitting prices from a plurality of providers of the identified product.

7. The method of claim 1 wherein the wireless address is a phone number.

8. The method of claim 1 wherein the encoding is from a label that is scanned by the handheld customer communications device.

9. The method of claim 8 wherein the label is attached to the product, to a product display, or to product packaging.

10. The method of claim 1 wherein the encoding data is obtained from an image of the product, wherein the image is captured by the handheld customer communications device.

11. A method for providing an incentive message to a customer for purchase at a retail store that is associated with a retail merchandiser, the method executed at least in part by a computer system and comprising:
a) receiving, at a first processor having a first network address, a wireless transmission of data from an encoding, wherein the encoding is scanned using a handheld customer communications device that has a wireless address, wherein the encoding data identifies a retail product offered by the retail merchandiser;
b) obtaining, at the first processor, pricing information for the identified retail product from the retail merchandiser and from one or more alternate sellers;
c) transmitting the obtained pricing information to the wireless address for display on the handheld customer communications device;
d) receiving at the first processor an instruction from the handheld customer communications device at the wireless address, wherein the instruction indicates, as a selected product source, one of the one or more alternate sellers, wherein the instruction relates to a sale price for the retail product;
e) transmitting to the handheld customer communications device at the wireless address, an instruction that displays a prompt for entry of customer contact information, wherein the entered customer contact information includes at least a phone number or an email address;
f) receiving, from the handheld customer communications device at the wireless address, the entered customer contact information in response to the transmitted prompt;
g) obtaining a pricing decision from the retail merchandiser according to the sale price and the selected product source;
and
h) generating the incentive message according to the pricing decision and wirelessly transmitting the incentive message for display on the handheld communications device according to the customer contact information.

12. The method of claim 11 wherein the incentive message provides an electronic coupon.

13. A method for responding to a customer request for pricing information, the method executed at least in part by a computer system and comprising:
a) receiving, at a first processor having a first network address, data from an encoding that is scanned and wirelessly transmitted from a handheld customer communications device that has a wireless address,
wherein the encoding data identifies a retail product offered by a retail merchandiser;
b) transmitting pricing information related to the retail merchandiser and to one or more alternate sellers for display on the customer communications device at the wireless address;
c) receiving, at the first processor having the first network address, one or more product-source instructions from the handheld customer communications device at the wireless address, wherein the one or more product-source instructions indicate at least one of the alternate sellers, wherein the one or more product-source instructions relate to a sale price for the retail product from the at least one of the alternate sellers;
and
d) generating and transmitting to the customer communications device, in response to the one or more received product-source instructions, an electronic coupon for display, wherein the electronic coupon relates to purchase of the retail product from the retail merchandiser.

14. The method of claim 13 further comprising recording the wireless address when the encoding data is received.

15. The method of claim 13 wherein the encoding is scanned from a label that is attached to the product, to a product display, or to product packaging.

16. The method of claim 13 wherein the electronic coupon lists a name of a customer, wherein the name is associated with the wireless address that is associated with the handheld customer communications device.
